(19) United States
(12) Patent Application Publication
(10) Pub. No.: US 2022/0415117 A1
(43) Pub. Date: Dec. 29, 2022

(54) METHOD AND APPARATUS FOR DETECTING OBJECT EXCHANGE BEHAVIOR, ELECTRONIC DEVICE AND STORAGE MEDIUM

(71) Applicant: SENSETIME INTERNATIONAL PTE, LTD., Singapore (SG)

(72) Inventors: Xinxin WANG, Singapore (SG); Shuai Zhang, Singapore (SG); Kalyun Wang, Singapore (SG)

(21) Appl. No.: 17/363,555

(22) Filed: Jun. 30, 2021

Related U.S. Application Data
(63) Continuation of application No. PCT/IB2021/055685, filed on Jun. 25, 2021.

(51) Int. Cl. G07F 17/32; G06K 9/00

(52) U.S. Cl. CPC G07F 17/322; G07F 17/3241; G07F 17/3239; G06K 9/00335; G06K 9/00744

(57) ABSTRACT

Provided are a method and apparatus for detecting an object exchange behavior, an electronic device and a storage medium. The method includes that: a video stream of a target scenario is acquired; in a case where it is detected from a present image in the video stream that a first person places a to-be-exchanged object in a first preset region, a compliance detection is performed on a type of the to-be-exchanged object based on the present image to obtain a first detection result; and in a case where the first detection result is not compliant, alarm prompt information for characterizing a type error of the to-be-exchanged object is output.

### CROSS-REFERENCE TO RELATED APPLICATION

This is continuation application of international application PCT/IB2021/055685, filed on 25 Jun. 2021, which claims priority to Singaporean patent application No. 10202106719W, filed with IPOS on 21 Jun. 2021. The contents of international application PCT/IB2021/055685 and Singaporean patent application No. 10202106719W are incorporated herein by reference in their entireties.

### TECHNICAL FIELD

The disclosure relates to the technical field of computer visions, and more particularly, to a method and apparatus for detecting an object exchange behavior, an electronic device and a storage medium.

### BACKGROUND

At present, concerning some special scenarios needing the physical exchange, corresponding exchange procedures and rules are typically provided, and are followed by a person in charge of exchanging to make an exchange.

However, due to possible subjective reasons such as misunderstandings, tensions and exhaustions of people, the problem of an exchange error occurs during exchanging to cause an exchange failure, and the exchange needs to be made again.

### SUMMARY

The embodiments of the disclosure are intended to provide a method and apparatus for detecting an object exchange behavior, an electronic device and a storage medium.

The technical solutions in the embodiments of the disclosure are implemented as follows.

The embodiments of the disclosure provide a method for detecting an object exchange behavior, which may include the following operations.

A video stream of a target scenario is acquired.

In a case where it is detected from a present image in the video stream that a first person places a to-be-exchanged object in a first preset region, a compliance detection is performed on a type of the to-be-exchanged object based on the present image to obtain a first detection result.

In a case where the first detection result is not compliant, alarm prompt information for characterizing a type error of the to-be-exchanged object is output.

In some embodiments, the operation that the compliance detection is performed on the type of the to-be-exchanged object based on the present image to obtain the first detection result may include the following operations.

Personal information of a second person associated with the to-be-exchanged object, and preset exchangeable type information corresponding to the target scenario are acquired;

in a case where the type of the to-be-exchanged object is matched with an object type corresponding to the personal information, and the preset exchangeable type information, it is determined that the first detection result is compliant; and/or

in a case where the type of the to-be-exchanged object is not matched with the object type corresponding to the personal information, or, the preset exchangeable type information, it is determined that the first detection result is not compliant.

In some embodiments, the method may further include the following operations.

Before the compliance detection is performed on the type of the to-be-exchanged object based on the present image to obtain the first detection result, a preset take-away action of the first person and the to-be-exchanged object in the first preset region are sequentially detected for at least one frame of image in the video stream, wherein the preset take-away action may include an action for taking away the to-be-exchanged object from a preset object placement region.

At least one frame of image in which the preset take-way action of the first person is detected and the to-be-exchanged object is present in the first preset region is determined as the present image.

In some embodiments, the method may further include the following operations.

After it is detected from the present image that the first person places the to-be-exchanged object in the first preset region, a first image in which the first person places a target exchange object in a second preset region is continuously acquired based on the video stream, the target exchange object being an object for exchanging the to-be-exchanged object.

In a case where the first image is acquired, a compliance detection is performed on a type of the target exchange object based on the first image to obtain a second detection result.

In a case where the second detection result is not compliant, alarm prompt information for characterizing a type error of the target exchange object is output.

In some embodiments, the operation that the compliance detection is performed on the type of the target exchange object based on the first image to obtain the second detection result may include the following operations.

Preset type configuration information is acquired;

in a case where the type of the to-be-exchanged object is matched with the type of the target exchange object according to the preset type configuration information, it is determined that the second detection result is compliant; and/or

In a case where the type of the to-be-exchanged object is not matched with the type of the target exchange object according to the preset type configuration information, it is determined that the second detection result is not compliant.

In some embodiments, the operation that the compliance detection is performed on the type of the target exchange object based on the first image to obtain the second detection result may include the following operations.

Personal information of a second person associated with the to-be-exchanged object, and preset exchangeable type information corresponding to the target scenario are acquired;

in a case where the type of the target exchange object is matched with an object type corresponding to the personal information, and the preset exchangeable type information, it is determined that the second detection result is compliant; and/or

in a case where the type of the target exchange object is not matched with the object type corresponding to the personal information, or, the preset exchangeable type information, it is determined that the second detection result is not compliant.

In some embodiments, the method may further include the following operations.

Before the compliance detection is performed on the type of the target exchange object to obtain the second detection result, a first preset placement action of the first person and the target exchange object in the second preset region are sequentially detected for at least one frame of image after the present image in the video stream, wherein the preset placement action may include an action for placing the target exchange object in the second preset region; and

At least one frame of image in which the first preset placement action of the first person is detected and the target exchange object is present in the second preset region is determined as the first image.

In some embodiments, the method may further include the following operations.

After the first image is acquired, a second image in which the first person pushes the target exchange object out of the second preset region is continuously acquired based on the video stream.

In a case where the second image is acquired, values of the target exchange object and the to-be-exchanged object are detected based on the first image and the present image respectively.

In a case where the values of the target exchange object and the to-be-exchanged object are unequal, alarm prompt information for characterizing a value error of the target exchange object is output.

In some embodiments, the method may further include the following operations.

Before the values of the target exchange object and the to-be-exchanged object are detected based on the first image and the present image respectively, a second preset placement action of the first person and the target exchange object in a preset object placement region out of the second preset region are sequentially detected for at least one frame of image after the first image in the video stream, wherein the second preset placement action may include an action for placing the target exchange object in the preset object placement region.

At least one frame of image in which the second preset placement action of the first person is detected and the target exchange object is present in the second preset region is determined as the second image.

In some embodiments, the method may further include the following operations.

After the second image is acquired, a third image in which the first preset region does not contain the to-be-exchanged object is continuously acquired based on the video stream.

In a case where a duration for not acquiring the third image reaches a preset duration, alarm prompt information for characterizing that the to-be-exchanged object is not recycled is output.

In some embodiments, the method may further include the following operations.

Personal information of a second person associated with the to-be-exchanged object is acquired.

In a case where the second image is acquired, an association between the to-be-exchanged object and the personal information is removed, and the target exchange object is associated with the personal information.

In some embodiments, the target scenario may include a game table scenario; and the to-be-exchanged object may include a token, and the first preset region and the second preset region may include a preset operation region of the first person on the game table.

The embodiments of the disclosure provide an apparatus for detecting an object exchange behavior, which may include: an acquisition module, a detection module and an alarm module.

The acquisition module is configured to acquire a video stream of a target scenario.

The detection module is configured to perform, in a case where it is detected from a present image in the video stream that a first person places a to-be-exchanged object in a first preset region, a compliance detection on a type of the to-be-exchanged object based on the present image to obtain a first detection result.

The alarm module is configured to output, in a case where the first detection result is not compliant, alarm prompt information for characterizing a type error of the to-be-exchanged object.

In some embodiments, the detection module is specifically configured to acquire personal information of a second person associated with the to-be-exchanged object, and preset exchangeable type information corresponding to the target scenario; and determine, in a case where the type of the to-be-exchanged object is matched with an object type corresponding to the personal information, and the preset exchangeable type information, that the first detection result is compliant; and/or determine, in a case where the type of the to-be-exchanged object is not matched with the object type corresponding to the personal information, or, the preset exchangeable type information, that the first detection result is not compliant.

The detection module is further configured to sequentially detect, before performing the compliance detection on the type of the to-be-exchanged object based on the present image to obtain the first detection result, a preset take-away action of the first person and the to-be-exchanged object in the first preset region for at least one frame of image in the video stream, wherein the preset take-away action may include an action for taking away the to-be-exchanged object from a preset object placement region; and determine at least one frame of image in which the preset take-way action of the first person is detected and the to-be-exchanged object is present in the first preset region as the present image.

In some embodiments, the detection module is further configured to continuously acquire, after the detection module detects from the present image that the first person places the to-be-exchanged object in the first preset region, based on the video stream, a first image in which the first person places a target exchange object in a second preset region, the target exchange object being an object for exchanging the to-be-exchanged object; and perform, in a case where the first image is acquired, a compliance detection on a type of the target exchange object based on the first image to obtain a second detection result.

The alarm module is further configured to output, in a case where the second detection result is not compliant, alarm prompt information for characterizing a type error of the target exchange object.

In some embodiments, the detection module is specifically configured to acquire preset type configuration information; and determine, in a case where the type of the to-be-exchanged object is matched with the type of the target exchange object according to the preset type configuration information, that the second detection result is compliant; and/or determine, in a case where the type of the to-be-exchanged object is not matched with the type of the target exchange object according to the preset type configuration information, that the second detection result is not compliant.

In some embodiments, the detection module is specifically configured to acquire personal information of a second person associated with the to-be-exchanged object, and preset exchangeable type information corresponding to the target scenario; and determine, in a case where the type of the target exchange object is matched with an object type corresponding to the personal information, and the preset exchangeable type information, that the second detection result is compliant; and/or determine, in a case where the type of the target exchange object is not matched with the object type corresponding to the personal information, or, the preset exchangeable type information, that the second detection result is not compliant.

In some embodiments, the detection module is further configured to sequentially detect, before performing the compliance detection on the type of the target exchange object to obtain the second detection result, a first preset placement action of the first person and the target exchange object in the second preset region for at least one frame of image after the present image in the video stream, wherein the preset placement action may include an action for placing the target exchange object in the second preset region; and determine at least one frame of image in which the first preset placement action of the first person is detected and the target exchange object is present in the second preset region as the first image.

In some embodiments, the detection module is further configured to continuously acquire, after acquiring the first image, based on the video stream, a second image in which the first person pushes the target exchange object out of the second preset region; and detect, in a case where the second image is acquired, values of the target exchange object and the to-be-exchanged object based on the first image and the present image respectively.

The alarm module is further configured to output, in a case where the values of the target exchange object and the to-be-exchanged object are unequal, alarm prompt information for characterizing a value error of the target exchange object.

In some embodiments, the detection module is further configured to sequentially detect, before detecting the values of the target exchange object and the to-be-exchanged object based on the first image and the present image respectively, a second preset placement action of the first person and the target exchange object in a preset object placement region out of the second preset region for at least one frame of image after the first image in the video stream, wherein the second preset placement action may include an action for placing the target exchange object in the preset object placement region; and determine at least one frame of image in which the second preset placement action of the first person is detected and the target exchange object is present in the second preset region as the second image.

In some embodiments, the detection module is further configured to continuously acquire, after acquiring the second image, based on the video stream, a third image in which the first preset region does not contain the to-be-exchanged object.

The alarm module is further configured to output, in a case where a duration for not acquiring the third image reaches a preset duration, alarm prompt information for characterizing that the to-be-exchanged object is not recycled.

In some embodiments, the detection module is further configured to acquire personal information of a second person associated with the to-be-exchanged object; and remove, in a case where the second image is acquired, an association between the to-be-exchanged object and the personal information, and associate the target exchange object with the personal information.

In some embodiments, the target scenario may include a game table scenario; and the to-be-exchanged object may include a token, and the first preset region and the second preset region may include a preset operation region of the first person on the game table.

The embodiments of the disclosure provide an electronic device, which may include: a processor, a memory and a communication bus.

The communication bus is configured to implement connection and communication between the processor and the memory.

The processor is configured to execute one or more programs stored in the memory, to implement the method for detecting the object exchange behavior.

The embodiments of the disclosure provide a computer-readable storage medium, storing one or more programs; and the one or more programs may be executed by one or more processors, to implement the method for detecting the object exchange behavior.

The disclosure provides the method and apparatus for detecting the object exchange behavior, the electronic device and the storage medium. The method includes that: a video stream of a target scenario is acquired; in a case where it is detected from a present image in the video stream that a first person places a to-be-exchanged object in a first preset region, a compliance detection is performed on a type of the to-be-exchanged object based on the present image to obtain a first detection result; and in a case where the first detection result is not compliant, alarm prompt information for characterizing a type error of the to-be-exchanged object is output. According to the technical solutions provided by the embodiments of the disclosure, in the process of determining the exchange, whether the type of the to-be-exchanged object in the scenario is compliant is detected, and the information for prompting of correcting the wrong operation in the scenario is timely output in a case where the type is not compliant. The disclosure improves the object exchange accuracy.

### BRIEF DESCRIPTION OF THE DRAWINGS

FIG. 1 illustrates a first flowchart schematic diagram of a method for detecting an object exchange behavior provided by an embodiment of the disclosure.

FIG. 2 illustrates a second flowchart schematic diagram of a method for detecting an object exchange behavior provided by an embodiment of the disclosure.

FIG. 3 illustrates a third flowchart schematic diagram of a method for detecting an object exchange behavior provided by an embodiment of the disclosure.

FIG. 4 illustrates a fourth flowchart schematic diagram of a method for detecting an object exchange behavior provided by an embodiment of the disclosure.

FIG. 5 illustrates a detection flowchart schematic diagram of an exemplary object exchange process provided by an embodiment of the disclosure.

FIG. 6 illustrates a structural schematic diagram of an apparatus for detecting an object exchange behavior provided by an embodiment of the disclosure.

FIG. 7 illustrates a structural schematic diagram of an electronic device provided by an embodiment of the disclosure.

### DETAILED DESCRIPTION

A clear and complete description on the technical solutions in the embodiments of the disclosure will be given below, in combination with the accompanying drawings in the embodiments of the disclosure.

The embodiments of the disclosure provide a method for detecting an object exchange behavior. The execution main body may be an apparatus for detecting the object exchange behavior. For example, the method for detecting the object exchange behavior may be executed by a terminal device or a server or other electronic devices. The terminal device may be User Equipment (UE), a mobile device, a user terminal, a cell phone, a cordless phone, a Personal Digital Assistant (PDA), a handheld device, a computing device, a vehicle-mounted device, a wearable device, etc. In some possible implementation modes, the method for detecting the object exchange behavior may be implemented by enabling a processor to call a computer-readable instruction stored in a memory.

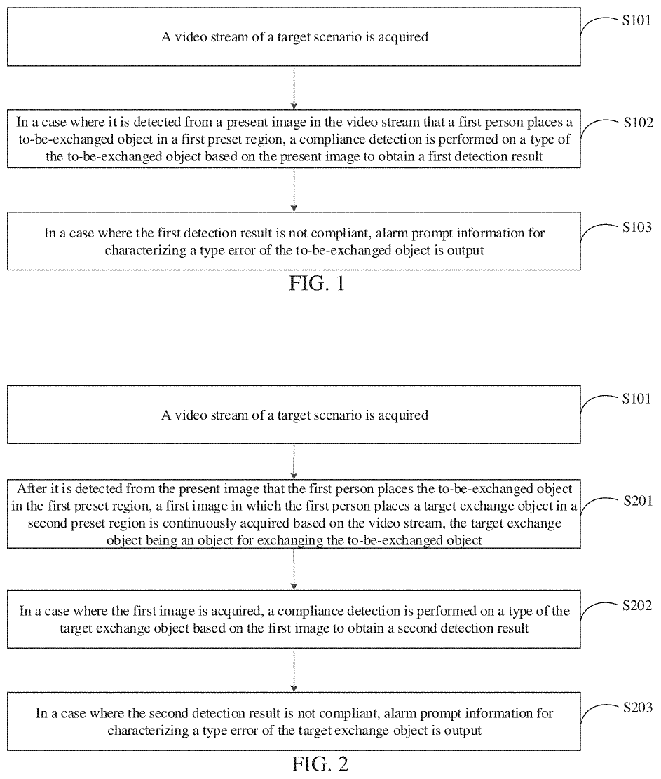

FIG. 1 illustrates a first flowchart schematic diagram of a method for detecting an object exchange behavior provided by an embodiment of the disclosure. As shown in FIG. 1, in the embodiment of the disclosure, the method for detecting the object exchange behavior mainly includes the following steps.

In S101, a video stream of a target scenario is acquired.

In the embodiment of the disclosure, the detection apparatus may acquire the video stream of the target scenario.

It is to be noted that in the embodiment of the disclosure, the target scenario may be any scenario that exchanges one object into another object, and may, for example, be a special game table scenario. The specific target scenario is not limited by the embodiment of the disclosure.

It is to be noted that in the embodiment of the disclosure, the detection apparatus may include may include a camera module. The detection apparatus is deployed around the target scenario to collect an image of the target scenario. In addition, the image of the target scenario may also be collected by an independent camera deployed around the target scenario. The video stream of the target scenario collected by the camera is transmitted to the detection apparatus. The specific mode for acquiring the video stream of the target scenario may be determined according to an actual demand and an apparatus configuration, and is not limited by the embodiment of the disclosure.

In S102, in a case where it is detected from a present image in the video stream that a first person places a to-be-exchanged object in a first preset region, a compliance detection is performed on a type of the to-be-exchanged object based on the present image to obtain a first detection result.

In the embodiment of the disclosure, the detection apparatus performs, in the case of detecting from the present image in the video stream that the first person places the to-be-exchanged object in the first preset region, the compliance detection on the type of the to-be-exchanged object based on the present image to obtain the first detection result.

It is to be noted that in the embodiment of the disclosure, the target scenario may be the game table scenario. In the game table scenario, tokens to be used by different types of game players are varied and thus need to be exchanged. The token provided by the player and needing to be exchanged may serve as the to-be-exchanged object, and the person who offers a token exchange service to the player may serve as the first person. The first preset region may include a preset operation region of the first person on the game table. The specific first person, to-be-exchanged object and first preset region may be determined according to an actual target scenario, and are not limited by the embodiment of the disclosure.

Specifically, in the embodiment of the disclosure, the detection apparatus performs the compliance detection on the type of the to-be-exchanged object based on the present image to obtain the first detection result, which may include that: personal information of a second person associated with the to-be-exchanged object, and preset exchangeable type information corresponding to the target scenario are acquired; and in a case where the type of the to-be-exchanged object is matched with an object type corresponding to the personal information, and the preset exchangeable type information, it is determined that the first detection result is compliant; and/or, in a case where the type of the to-be-exchanged object is not matched with the object type corresponding to the personal information, or, the preset exchangeable type information, it is determined that the first detection result is not compliant.

It is to be understood that in the embodiment of the disclosure, the person offering the to-be-exchanged object is the second person associated with the to-be-exchanged object. The detection apparatus may acquire the personal information of the second person. The personal information may include information on whether the person is a member and the like. The specific second person and personal information of the second person are not limited by the embodiment of the disclosure. The type of the to-be-exchanged object may be matched or not matched with an object type corresponding to the personal information, the object type corresponding to the personal information represents a type of a to-be-exchanged object that the second person is allowed to use. For example, the personal information includes that the second person is the member, the object type corresponding to which being an object type that only the member can exchange; therefore, when the type of the to-be-exchanged object is the object type that only the member can exchange, the type of the to-be-exchanged object is matched with the object type corresponding to the personal information.

It is to be noted that in the embodiment of the disclosure, the second person associated with the to-be-exchanged object and personal information of the second person may be pre-stored in the detection apparatus. Certainly, the detection apparatus may acquire them from other management devices. In addition, if the local detection apparatus and other management devices does not store the personal information of the second person, the first person may also directly select the second person, and input the personal information to the detection apparatus. The specific mode for acquiring the personal information is not limited by the embodiment of the disclosure.

It is to be understood that in the embodiment of the disclosure, the object type that may be exchanged is limited for the target scenario. The detection apparatus may directly acquire the preset exchangeable type information corresponding to the target scenario, the preset exchangeable type information including the object type that may be exchanged in the target scenario. As the type of the to-be-exchanged object may be unnecessarily exchangeable in the target scenario, there is a need to match the type of the to-be-exchanged object with the preset exchangeable type information.

It is to be noted that in the embodiment of the disclosure, the type of the to-be-exchanged object is matched with the object type corresponding to the personal information and the preset exchangeable type information at the same time, such that the first detection result is compliant, or otherwise, the first detection result is not compliant.

It is to be noted that in the embodiment of the disclosure, the detection apparatus may further execute the following steps before performing the compliance detection on the type of the to-be-exchanged object based on the present image: a preset take-away action of the first person and the to-be-exchanged object in the first preset region are sequentially detected for at least one frame of image in the video stream, wherein the preset take-away action may include an action for taking away the to-be-exchanged object from a preset object placement region; and at least one frame of image in which the preset take-way action of the first person is detected and the to-be-exchanged object is present in the first preset region is determined as the present image.

It is to be understood that in the embodiment of the disclosure, the detection apparatus first determines the present image from the video stream of the target scenario, and then can perform the compliance detection on the type of the to-be-exchanged object based on the present image. The detection apparatus sequentially detects the preset take-away action of the first person for the at least one frame of image in the video stream. Specifically, it may be implemented in a mode of detecting the action of the first person based on multiple continuous frames of images, and may also be implemented in a mode of continuously detecting, through the video stream, a position of the to-be-exchanged object and whether a person to which a hand operating the to-be-exchanged object belongs is the first person. Specifically, the present image may be one frame of image, and may also be multiple frames of images, which is not limited by the embodiment of the disclosure.

In S103, in a case where the first detection result is not compliant, alarm prompt information for characterizing a type error of the to-be-exchanged object is output.

In the embodiment of the disclosure, after obtaining the first detection result, the detection apparatus outputs the alarm prompt information for characterizing the type error of the to-be-exchanged object in the case where the first detection result is not compliant.

It is to be understood that in the embodiment of the disclosure, in the case where the first detection result is not compliant, the type of the to-be-exchanged object is not compliant and cannot be exchanged in the target scenario, the detection apparatus may timely output the alarm prompt information for characterizing the type error of the to-be-exchanged object, and the person who places the to-be-exchanged object in the first preset region may timely know that the object cannot be exchanged and return the to-be-exchanged object to the associated second person, thereby improving the object exchange accuracy.

FIG. 2 illustrates a second flowchart schematic diagram of a method for detecting an object exchange behavior provided by an embodiment of the disclosure. As shown in FIG. 2, in the embodiment of the disclosure, the detection apparatus may further execute the following steps after executing Step S101.

In S201, after it is detected from the present image that the first person places the to-be-exchanged object in the first preset region, a first image in which the first person places a target exchange object in a second preset region is continuously acquired based on the video stream, the target exchange object being an object for exchanging the to-be-exchanged object.

In the embodiment of the disclosure, the detection apparatus continuously acquires, in the case of detecting from the present image that the first person places the to-be-exchanged object in the first preset region, based on the video stream, the first image in which the first person places the target exchange object for exchanging the to-be-exchanged object in the second preset region.

It is to be noted that in the embodiment of the disclosure, the target scenario includes the game table scenario, and the second preset region includes the preset operation region of the first person on the game table. The specific second preset region is not limited in the embodiment of the disclosure.

Specifically, in the embodiment of the disclosure, the detection module sequentially detects a first preset placement action of the first person and the target exchange object in the second preset region for at least one frame of image after the present image in the video stream, wherein the preset placement action may include an action for placing the target exchange object in the second preset region; and determines at least one frame of image in which the first preset placement action of the first person is detected and the target exchange object is present in the second preset region as the first image.

It is to be understood that in the embodiment of the disclosure, the present image is an image in which the first person places the to-be-exchanged object in the first preset region in the video stream; and thereafter, as a matter of fact, the first person places the target exchange object for exchanging the to-be-exchanged object in the second preset region. Therefore, the detection apparatus sequentially detects the first preset placement action of the first person and the target exchange object in the second preset region for at least one frame of image after the present image in the video stream. The detection apparatus sequentially detects the first preset placement action of the first person for at least one frame of image after the present image in the video stream. Specifically, it may be implemented in a mode of detecting the action of the first person based on multiple continuous frames of images, and may also be implemented in a mode of continuously detecting, through the video stream, a position of the target exchange object and whether a person to which a hand operating the target exchange object belongs is the first person. Specifically, the first image may be one frame of image, and may also be multiple frames of images, which is not limited by the embodiment of the disclosure.

In S202, in a case where the first image is acquired, a compliance detection is performed on a type of the target exchange object based on the first image to obtain a second detection result.

In the embodiment of the disclosure, in the case where the first image is acquired, i.e., the target exchange object is placed in the second preset region, the detection apparatus may perform the compliance detection on the type of the target exchange object based on the first image to obtain the second detection result.

Specifically, in the embodiment of the disclosure, the detection apparatus performs the compliance detection on the target exchange object based on the first image to obtain the second detection result, which may include that: preset type configuration information is acquired; in a case where the type of the to-be-exchanged object is matched with the type of the target exchange object according to the preset type configuration information, it is determined that the second detection result is compliant; and/or, in a case where the type of the to-be-exchanged object is not matched with the type of the target exchange object according to the preset type configuration information, it is determined that the second detection result is not compliant.

It is to be noted that in the embodiment of the disclosure, the preset type configuration information is the object type set for exchanging different types of objects. The specific preset type configuration information may be set according to an actual demand and an application scenario, and is not limited by the embodiment of the disclosure.

Exemplarily, in the embodiment of the disclosure, the preset type configuration information includes: the exchange object matched with the object of the type A is the object of the type B and C, and the exchange object matched with the object of the type B is the object of the type A and D. If the type of the to-be-exchanged object is A, and the type of the target exchange object is D, the object of the type A is not matched with the object of the type D in the preset type configuration information, and thus the detection apparatus may determine that the second detection result is not compliant. If the type of the to-be-exchanged object is A, and the type of the target exchange object is B, the object of the type A is not matched with the object of the type B in the preset type configuration information, and thus the detection apparatus may determine that the second detection result is compliant.

It is to be noted that, in the embodiment of the disclosure, the detection apparatus performs the compliance detection on the type of the target exchange object. Not only may whether to be matched with the type of the to-be-exchanged object be detected, but the detection may also be made based on other type setting rules, which is not limited by the embodiment of the disclosure.

Specifically, in the embodiment of the disclosure, the detection apparatus performs the compliance detection on the type of the target exchange object based on the first image to obtain the second detection result, which may further include that: personal information of a second person associated with the to-be-exchanged object, and preset exchangeable type information corresponding to the target scenario are acquired; in a case where the type of the target exchange object is matched with an object type corresponding to the personal information, and the preset exchangeable type information, it is determined that the second detection result is compliant; and/or in a case where the type of the target exchange object is not matched with the object type corresponding to the personal information, or, the preset exchangeable type information, it is determined that the second detection result is not compliant.

It is to be understood that in the embodiment of the disclosure, the detection apparatus may acquire the personal information of the second person. The personal information may include information on whether the person is a member and the like. The type of the target exchange object may be matched with an object type corresponding to the personal information. For example, the personal information is that the second person is the member and only the member can exchange the object with the type of the target exchange object, i.e., it is allowed that the target exchange object is exchanged to the second person. Certainly, the type of the target exchange object may also not be matched with the object type corresponding to the personal information. For example, the personal information is that the second person is not the member and only the member can exchange the object with the type of the target exchange object, i.e., it is not allowed that the target exchange object is exchanged to the second person.

It is to be understood that in the embodiment of the disclosure, the object type that may be exchanged is limited for the target scenario. The detection apparatus may directly acquire the preset exchangeable type information corresponding to the target scenario, the preset exchangeable type information including the object type that may be exchanged in the target scenario. As the type of the target exchange object may be unnecessarily exchangeable in the target scenario, there is a need to match the type of the target exchange object with the preset exchangeable type information.

In S203, in a case where the second detection result is not compliant, alarm prompt information for characterizing a type error of the target exchange object is output.

In the embodiment of the disclosure, after obtaining the second detection result, the detection apparatus outputs the alarm prompt information for characterizing the type error of the target exchange object in the case where the second detection result is not compliant.

It is to be understood that in the embodiment of the disclosure, in the case where the second detection result is not compliant, the type of the target exchange object is not compliant and cannot be exchanged in the target scenario, the detection apparatus may timely output the alarm prompt information for characterizing the type error of the target exchange object, and the person may timely know that the target exchange object cannot be exchanged and take back the target exchange object, thereby improving the object exchange accuracy.

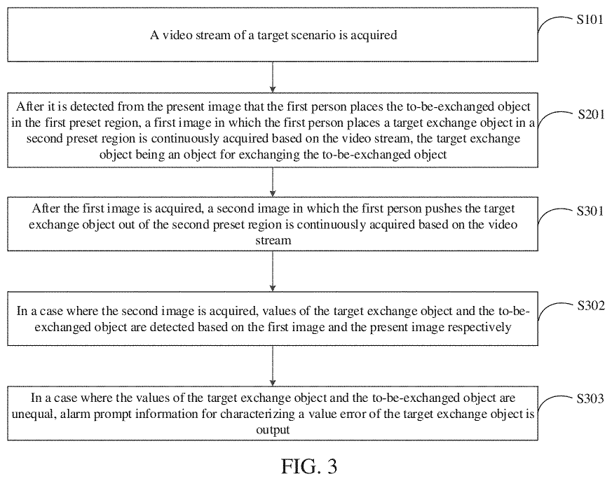

FIG. 3 illustrates a third flowchart schematic diagram of a method for detecting an object exchange behavior provided by an embodiment of the disclosure. As shown in FIG. 3, in the embodiment of the disclosure, the detection apparatus may further execute the following steps after executing Step S201.

In S301, after the first image is acquired, a second image in which the first person pushes the target exchange object out of the second preset region is continuously acquired based on the video stream.

In the embodiment of the disclosure, after acquiring the first image, the detection apparatus may continuously acquire, based on the video stream, the second image in which the first person pushes the target exchange object out of the second preset region.

Specifically, in the embodiment of the disclosure, the detection module sequentially detects a second preset placement action of the first person and the target exchange object in a preset object placement region out of the second preset region for at least one frame of image after the first image in the video stream, wherein the second preset placement action may include an action for placing the target exchange object in the preset object placement region; and determines at least one frame of image in which the second preset placement action of the first person is detected and the target exchange object is present in the second preset region as the second image.

It is to be understood that in the embodiment of the disclosure, the detection apparatus sequentially detects the first preset placement action of the first person for at least one frame of image after the present image in the video stream. Specifically, it may be implemented in a mode of detecting the action of the first person based on multiple continuous frames of images, and may also be implemented in a mode of continuously detecting, through the video stream, a position of the target exchange object and whether a person to which a hand operating the target exchange object belongs is the first person. Specifically, the second image may be one frame of image, and may also be multiple frames of images, which is not limited by the embodiment of the disclosure.

In S302, in a case where the second image is acquired, values of the target exchange object and the to-be-exchanged object are detected based on the first image and the present image respectively.

In the embodiment of the disclosure, in the case where the detection apparatus acquires the second image, the first person pushed the target exchange object out of the second preset region. By this time, it is indicated that the first person has confirmed that the selected target exchange object may be used to exchange the to-be-exchanged object. The detection apparatus further detects the values of the target exchange object and the to-be-exchanged object based on the first image and the present image respectively.

It is to be understood that in the embodiment of the disclosure, the target exchange object is configured to exchange the to-be-exchanged object. The exchange principle is that values to be exchanged are equal. However, the first person may have a determination error such that the value of the selected target exchange object is unequal to that of the to-be-exchanged object. Hence, the detection apparatus needs to make a further detection on the values.

In S303, in a case where the values of the target exchange object and the to-be-exchanged object are unequal, alarm prompt information for characterizing a value error of the target exchange object is output.

In the embodiment of the disclosure, after detecting the values of the target exchange object and the to-be-exchanged object respectively, the detection apparatus outputs, in the case where the values of the target exchange object and the to-be-exchanged object are unequal, the alarm prompt information for characterizing the value error of the target exchange object.

It is to be understood that in the embodiment of the disclosure, in the case where the values of the target exchange object and the to-be-exchanged object are unequal, the exchange cannot be made in the target scenario. Therefore, the detection apparatus may timely output the alarm prompt information for characterizing the value error of the to-be-exchanged object to prompt the first person of adjusting the number of target exchange objects, such that the value of the target exchange object is equal to that of the to-be-exchanged object, thereby implementing the object exchange, and improving the object exchange accuracy.

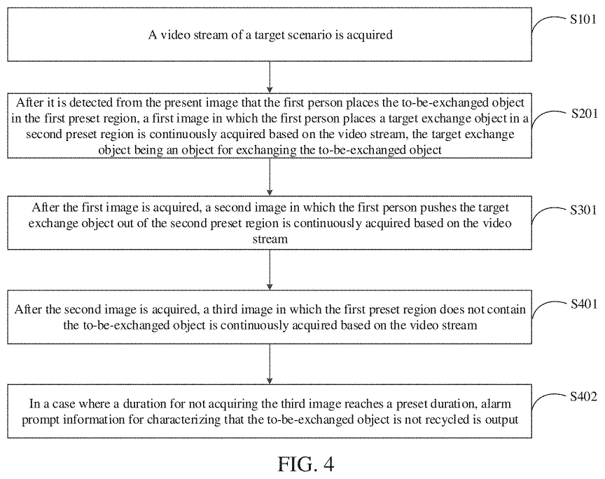

FIG. 4 illustrates a fourth flowchart schematic diagram of a detection method provided by an embodiment of the disclosure. As shown in FIG. 4, in the embodiment of the disclosure, the detection apparatus may further execute the following steps after executing Step S301.

In S401, after the second image is acquired, a third image in which the first preset region does not contain the to-be-exchanged object is continuously acquired based on the video stream.

In the embodiment of the disclosure, after acquiring the second image, the detection apparatus may continuously acquire, based on the video stream, the third image in which the first preset region does not contain the to-be-exchanged object.

It is to be understood that in the embodiment of the disclosure, the detection apparatus may sequentially detect whether the first preset region includes the to-be-exchanged object for at least one frame of image after the second image in the video stream, and determine at least one frame of image in which the first preset region does not contain the to-be-exchanged object as the third image.

In S402, in a case where a duration for not acquiring the third image reaches a preset duration, alarm prompt information for characterizing that the to-be-exchanged object is not recycled is output.

In the embodiment of the disclosure, in the case where the duration for not acquiring the third image reaches the preset duration, the detection apparatus outputs the alarm prompt information for characterizing that the to-be-exchanged object is not recycled.

It is to be noted that in the embodiment of the disclosure, the detection apparatus stores the preset duration. The specific preset duration may be set according to an actual demand and an application scenario, and is not limited by the embodiment of the disclosure.

It is to be understood that in the embodiment of the disclosure, the detection apparatus starts timing when acquiring the third image after the values of the target exchange object and the to-be-exchanged object are equal. If the third image is not acquired within the preset duration, i.e., the to-be-exchanged object is in the first preset region, the first person may forget to recycle the to-be-exchanged object after exchanging the target exchange object. Therefore, the detection apparatus may output the alarm prompt information for characterizing that the to-be-exchanged object is not recycled, and the first person may timely recycle the to-be-exchanged object after viewing the alarm prompt information.

It is to be noted that in the embodiment of the disclosure, the detection apparatus may further execute the following steps upon the completion of the exchange: personal information of a second person associated with the to-be-exchanged object is acquired; and in a case where the second image is acquired, an association between the to-be-exchanged object and the personal information is removed, and the target exchange object is associated with the personal information.

It is to be understood that in the embodiment of the disclosure, the object held by the second person in fact has changed upon the completion of the exchange. Therefore, the detection apparatus removes the association between the to-be-exchanged object and the personal information of the second person, and increases the association between the target exchange object and the personal information of the second person, which facilitates tracing in the subsequent application of the target exchange object to know relevant information of the associated person for corresponding processing, thereby ensuring correctness in use. In addition, the to-be-exchanged object may also be provided for other persons for use, to improve the utilization rate of the object.

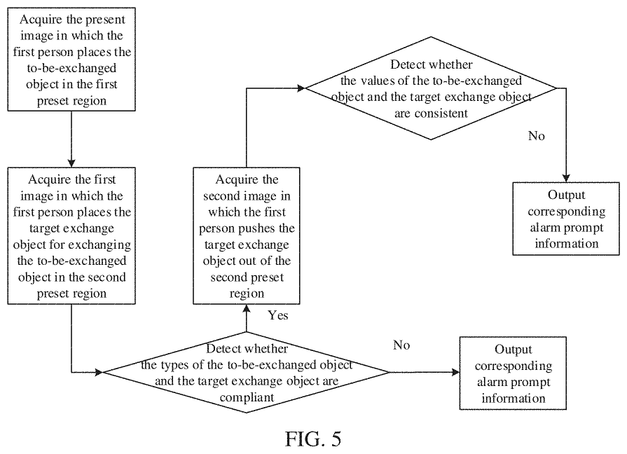

FIG. 5 illustrates a detection flowchart schematic diagram of an exemplary object exchange process provided by an embodiment of the disclosure. As shown in FIG. 5, in the embodiment of the disclosure, in a case where the second person associated with the to-be-exchanged object requires to exchange the to-be-exchanged object, the detection apparatus may acquire the present image in which the first person places the to-be-exchanged object in the first preset region, may then acquire the first image in which the first person places the target exchange object for exchanging the to-be-exchanged object in the second preset region, detects whether the types of the to-be-exchanged object and the target exchange object are compliant, outputs corresponding alarm prompt information in a case where the types are not compliant such that the first person may make adjustments, acquires the second image in which the first person pushes the target exchange object out of the second preset region in a case where the types are compliant, then detects whether the values of the to-be-exchanged object and the target exchange object are consistent, and outputs corresponding alarm prompt information in a case where the values are not consistent.

It is to be noted that in the embodiment of the disclosure, after detecting whether the types of the to-be-exchanged object and the target exchange object are compliant, the detection apparatus may output the corresponding alarm prompt information in the case where the types are not compliant, and may further first send the to-be-exchanged object and the target exchange object as well as the personal information of the second person to other management devices for storage in the other management devices in the case where the types are not compliant.

The embodiment of the disclosure provides the method for detecting the object exchange behavior, which includes that: a video stream of a target scenario is acquired; in a case where it is detected from a present image in the video stream that a first person places a to-be-exchanged object in a first preset region, a compliance detection is performed on a type of the to-be-exchanged object based on the present image to obtain a first detection result; and in a case where the first detection result is not compliant, alarm prompt information for characterizing a type error of the to-be-exchanged object is output. According to the method for detecting the object exchange behavior provided by the embodiment of the disclosure, in the process of determining the exchange, whether the type of the to-be-exchanged object in the scenario is compliant is detected, and the information for prompting of correcting the wrong operation in the scenario is timely output in a case where the type is not compliant. The method improves the object exchange accuracy.

The embodiments of the disclosure provide an apparatus for detecting an object exchange behavior. FIG. 6 illustrates a structural schematic diagram of an apparatus for detecting an object exchange behavior provided by an embodiment of the disclosure. As shown in FIG. 6, the detection apparatus may include an acquisition module 601, a detection module 602 and an alarm module 603.

The acquisition module 601 is configured to acquire a video stream of a target scenario.

The detection module 602 is configured to perform, in a case where it is detected from a present image in the video stream that a first person places a to-be-exchanged object in a first preset region, a compliance detection on a type of the to-be-exchanged object based on the present image to obtain a first detection result.

The alarm module 603 is configured to output, in a case where the first detection result is not compliant, alarm prompt information for characterizing a type error of the to-be-exchanged object.

In an embodiment of the disclosure, the detection module 602 is specifically configured to acquire personal information of a second person associated with the to-be-exchanged object, and preset exchangeable type information corresponding to the target scenario; and determine, in a case where the type of the to-be-exchanged object is matched with an object type corresponding to the personal information, and the preset exchangeable type information, that the first detection result is compliant; and/or determine, in a case where the type of the to-be-exchanged object is not matched with the object type corresponding to the personal information, or, the preset exchangeable type information, that the first detection result is not compliant.

In an embodiment of the disclosure, the detection module 602 is further configured to sequentially detect, before performing the compliance detection on the type of the to-be-exchanged object based on the present image to obtain the first detection result, a preset take-away action of the first person and the to-be-exchanged object in the first preset region for at least one frame of image in the video stream, wherein the preset take-away action comprises an action for taking away the to-be-exchanged object from a preset object placement region; and determine at least one frame of image in which the preset take-way action of the first person is detected and the to-be-exchanged object is present in the first preset region as the present image.

In an embodiment of the disclosure, the detection module 602 is further configured to continuously acquire, after the detection module detects from the present image that the first person places the to-be-exchanged object in the first preset region, based on the video stream, a first image in which the first person places a target exchange object in a second preset region, the target exchange object being an object for exchanging the to-be-exchanged object; and perform, in a case where the first image is acquired, a compliance detection on a type of the target exchange object based on the first image to obtain a second detection result.

The alarm module 603 is further configured to output, in a case where the second detection result is not compliant, alarm prompt information for characterizing a type error of the target exchange object.

In an embodiment of the disclosure, the detection module 602 is specifically configured to acquire preset type configuration information; and determine, in a case where the type of the to-be-exchanged object is matched with the type of the target exchange object according to the preset type configuration information, that the second detection result is compliant; and/or determine, in a case where the type of the to-be-exchanged object is not matched with the type of the target exchange object according to the preset type configuration information, that the second detection result is not compliant.

In an embodiment of the disclosure, the detection module 602 is specifically configured to acquire personal information of a second person associated with the to-be-exchanged object, and preset exchangeable type information corresponding to the target scenario; and determine, in a case where the type of the target exchange obj ect is matched with an object type corresponding to the personal information, and the preset exchangeable type information, that the second detection result is compliant; and/or determine, in a case where the type of the target exchange object is not matched with the object type corresponding to the personal information, or, the preset exchangeable type information, that the second detection result is not compliant.

In an embodiment of the disclosure, the detection module 602 is further configured to sequentially detect, before performing the compliance detection on the type of the target exchange object to obtain the second detection result, a first preset placement action of the first person and the target exchange object in the second preset region for at least one frame of image after the present image in the video stream, wherein the preset placement action may include an action for placing the target exchange object in the second preset region; and determine at least one frame of image in which the first preset placement action of the first person is detected and the target exchange object is present in the second preset region as the first image.

In an embodiment of the disclosure, the detection module 602 is further configured to continuously acquire, after acquiring the first image, based on the video stream, a second image in which the first person pushes the target exchange object out of the second preset region; and detect, in a case where the second image is acquired, values of the target exchange object and the to-be-exchanged object based on the first image and the present image respectively.

The alarm module 603 is further configured to output, in a case where the values of the target exchange object and the to-be-exchanged object are unequal, alarm prompt information for characterizing a value error of the target exchange object.

In an embodiment of the disclosure, the detection module 602 is further configured to sequentially detecting, before detecting the values of the target exchange object and the to-be-exchanged object based on the first image and the present image respectively, a second preset placement action of the first person and the target exchange object in a preset object placement region out of the second preset region for at least one frame of image after the first image in the video stream, wherein the second preset placement action may include an action for placing the target exchange object in the preset object placement region; and determine at least one frame of image in which the second preset placement action of the first person is detected and the target exchange object is present in the second preset region as the second image.

In an embodiment of the disclosure, the detection module 602 is further configured to continuously acquire, after acquiring the second image, based on the video stream, a third image in which the first preset region does not contain the to-be-exchanged object.

The alarm module 603 is further configured to output, in a case where a duration for not acquiring the third image reaches a preset duration, alarm prompt information for characterizing that the to-be-exchanged object is not recycled.

In an embodiment of the disclosure, the detection module 602 is further configured to acquire personal information of a second person associated with the to-be-exchanged object; and remove, in a case where the second image is acquired, an association between the to-be-exchanged object and the personal information, and associate the target exchange object with the personal information.

In some embodiments, the target scenario may include a game table scenario; and the to-be-exchanged object may include a token, and the first preset region and the second preset region may include a preset operation region of the first person on the game table.

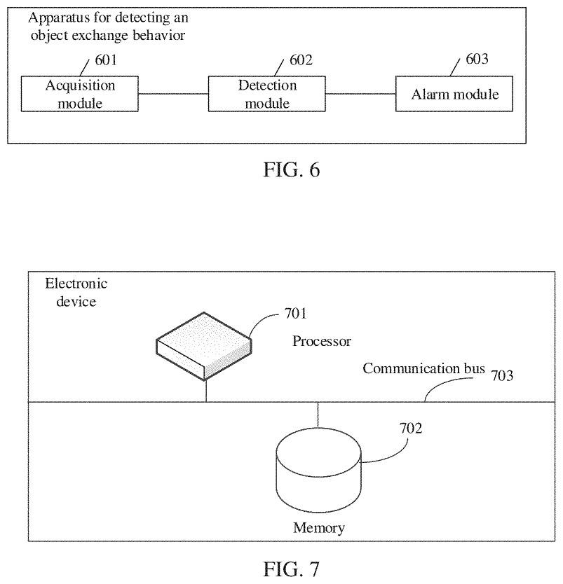

The embodiments of the disclosure provide an electronic device. FIG. 7 illustrates a structural schematic diagram of an electronic device provided by an embodiment of the disclosure. As shown in FIG. 7, the electronic device may include: a processor 701, a memory 702 and a communication bus 703.

The communication bus 703 is configured to implement connection and communication between the processor 701 and the memory 702.

The processor 701 is configured to execute one or more programs stored in the memory 702, to implement the method for detecting the object exchange behavior.

The embodiments of the disclosure further provide a computer-readable storage medium, storing one or more programs; and the one or more programs may be executed by one or more processors, to implement the method for detecting the object exchange behavior. The computer readable storage may be a volatile memory such as a Random-Access Memory (RAM), or a non-volatile memory such as a Read-Only Memory (ROM), a flash memory, a Hard Disk Drive (HDD) or a Solid-State Drive (SSD), or may also be a device including any one or combination of the above memories, such as a mobile phone, a computer, a tablet and a PDA.

Those skilled in the art should understand that the embodiments of the disclosure can provide a method, a system or a computer program product. Thus, forms of hardware embodiments, software embodiments or embodiments integrating software and hardware can be adopted in the disclosure. Moreover, a form of the computer program product implemented on one or more computer available storage media (including, but not limited to, a disk memory, an optical memory and the like) containing computer available program codes can be adopted in the disclosure.

The disclosure is described with reference to flowcharts and/or block diagrams of the method, the device (system) and the computer program product according to the embodiments of the disclosure. It should be understood that each flow and/or block in the flowcharts and/or the block diagrams and a combination of the flows and/or the blocks in the flowcharts and/or the block diagrams can be realized by computer program instructions. These computer program instructions can be provided for a general computer, a dedicated computer, an embedded processor or processors of other programmable data processing devices to generate a machine, so that an apparatus for realizing functions assigned in one or more flows of the flowcharts and/or one or more blocks of the block diagrams is generated via instructions executed by the computers or the processors of the other programmable data processing devices.

These computer program instructions can also be stored in a computer readable memory capable of guiding the computers or the other programmable data processing devices to work in a specific mode, so that a manufactured product including an instruction apparatus is generated via the instructions stored in the computer readable memory, and the instruction apparatus realizes the functions assigned in one or more flows of the flowcharts and/or one or more blocks of the block diagrams.

These computer program instructions can also be loaded to the computers or the other programmable data processing devices, so that processing realized by the computers is generated by executing a series of operation steps on the computers or the other programmable devices, and therefore the instructions executed on the computers or the other programmable devices provide a step of realizing the functions assigned in one or more flows of the flowcharts and/or one or more blocks of the block diagrams.

The above are merely preferred embodiments of the disclosure, rather than a limit to the protection scope of the disclosure.

1. A method for detecting an object exchange behavior, comprising:
acquiring a video stream of a target scenario;
performing, in a case of detecting from a present image in the video stream that a first person places a to-be-exchanged object in a first preset region, a compliance detection on a type of the to-be-exchanged object based on the present image to obtain a first detection result; and
outputting, in a case where the first detection result is not compliant, alarm prompt information for characterizing a type error of the to-be-exchanged object.

2. The method of claim 1, wherein performing the compliance detection on the type of the to-be-exchanged object based on the present image to obtain the first detection result comprises:
acquiring personal information of a second person associated with the to-be-exchanged object, and preset exchangeable type information corresponding to the target scenario; and
determining, in a case where the type of the to-be-exchanged object is matched with an object type corresponding to the personal information, and the preset exchangeable type information, that the first detection result is compliant; and/or
determining, in a case where the type of the to-be-exchanged object is not matched with the object type corresponding to the personal information, or, the preset exchangeable type information, that the first detection result is not compliant.

3. The method of claim 1, wherein the method further comprises:
before performing the compliance detection on the type of the to-be-exchanged object based on the present image to obtain the first detection result, sequentially detecting a preset take-away action of the first person and the to-be-exchanged object in the first preset region for at least one frame of image in the video stream, wherein the preset take-away action comprises an action for taking away the to-be-exchanged object from a preset object placement region; and
determining at least one frame of image in which the preset take-away action of the first person is detected and the to-be-exchanged object is present in the first preset region as the present image.

4. The method of claim 1, wherein the method further comprises:
after detecting from the present image that the first person places the to-be-exchanged object in the first preset region, continuously acquiring, based on the video stream, a first image in which the first person places a target exchange object in a second preset region, the target exchange object being an object for exchanging the to-be-exchanged object;
performing, in a case of acquiring the first image, a compliance detection on a type of the target exchange object based on the first image to obtain a second detection result; and
outputting, in a case where the second detection result is not compliant, alarm prompt information for characterizing a type error of the target exchange object.

5. The method of claim 4, wherein performing the compliance detection on the type of the target exchange object based on the first image to obtain the second detection result comprises:
acquiring preset type configuration information; and
determining, in a case where the type of the to-be-exchanged object is matched with the type of the target exchange object according to the preset type configuration information, that the second detection result is compliant; and/or
determining, in a case where the type of the to-be-exchanged object is not matched with the type of the target exchange object according to the preset type configuration information, that the second detection result is not compliant.

6. The method of claim 4, wherein performing the compliance detection on the type of the target exchange object based on the first image to obtain the second detection result comprises:
acquiring personal information of a second person associated with the to-be-exchanged object, and preset exchangeable type information corresponding to the target scenario; and
determining, in a case where the type of the target exchange object is matched with an object type corresponding to the personal information, and the preset exchangeable type information, that the second detection result is compliant; and/or
determining, in a case where the type of the target exchange object is not matched with the object type corresponding to the personal information, or, the preset exchangeable type information, that the second detection result is not compliant.

7. The method of claim 4, wherein the method further comprises:
before performing the compliance detection on the type of the target exchange object to obtain the second detection result, sequentially detecting a first preset placement action of the first person and the target exchange object in the second preset region for at least one frame of image after the present image in the video stream, wherein the first preset placement action comprises an action for placing the target exchange object in the second preset region; and
determining at least one frame of image in which the first preset placement action of the first person is detected and the target exchange object is present in the second preset region as the first image.

8. The method of claim 4, wherein the method further comprises:
after acquiring the first image, continuously acquiring, based on the video stream, a second image in which the first person pushes the target exchange object out of the second preset region;
detecting, in a case of acquiring the second image, values of the target exchange object and the to-be-exchanged object based on the first image and the present image respectively; and
outputting, in a case where the values of the target exchange object and the to-be-exchanged object are unequal, alarm prompt information for characterizing a value error of the target exchange object.

9. The method of claim 8, wherein the method further comprises:
before detecting the values of the target exchange object and the to-be-exchanged object based on the first image and the present image respectively, sequentially detecting, a second preset placement action of the first person and the target exchange object in a preset object placement region out of the second preset region for at least one frame of image after the first image in the video stream, wherein the second preset placement action comprises an action for placing the target exchange object in the preset object placement region; and
determining at least one frame of image in which the second preset placement action of the first person is detected and the target exchange object is present in the second preset region as the second image.

10. The method of claim 8, wherein the method further comprises:
after acquiring the second image, continuously acquiring, based on the video stream, a third image in which the first preset region does not contain the to-be-exchanged object; and
outputting, in a case where a duration for not acquiring the third image reaches a preset duration, alarm prompt information for characterizing that the to-be-exchanged object is not recycled.

11. The method of claim 8, wherein the method further comprises:
acquiring personal information of a second person associated with the to-be-exchanged object; and
removing, in a case of acquiring the second image, an association between the to-be-exchanged object and the personal information, and associating the target exchange object with the personal information.

12. The method of claim 8, wherein the target scenario comprises a game table scenario; and the to-be-exchanged object comprises a token, and the first preset region and the second preset region comprise a preset operation region of the first person on a game table.

13. An electronic device, comprising a processor, a memory and a communication bus, wherein
the communication bus is configured to implement connection and communication between the processor and the memory; and
the processor is configured to execute one or more programs stored in the memory to implement a method for detecting an object exchange behavior, the method comprising:
acquiring a video stream of a target scenario;
performing, in a case of detecting from a present image in the video stream that a first person places a to-be-exchanged object in a first preset region, a compliance detection on a type of the to-be-exchanged object based on the present image to obtain a first detection result; and
outputting, in a case where the first detection result is not compliant, alarm prompt information for characterizing a type error of the to-be-exchanged object.

14. A nonvolatile computer-readable storage medium, storing one or more programs, wherein the one or more programs are able to be executed by one or more processors, to implement a method for detecting an object exchange behavior, the method comprising:
acquiring a video stream of a target scenario;
performing, in a case of detecting from a present image in the video stream that a first person places a to-be-exchanged object in a first preset region, a compliance detection on a type of the to-be-exchanged object based on the present image to obtain a first detection result; and
outputting, in a case where the first detection result is not compliant, alarm prompt information for characterizing a type error of the to-be-exchanged object.
